(19) United States
(12) Patent Application Publication
(10) Pub. No.: US 2015/0111601 A1
(43) Pub. Date: Apr. 23, 2015

(54) SYSTEMS AND METHODS FOR DISPLAYING DISTANT IMAGES AT MOBILE COMPUTING DEVICES

(71) Applicant: Logos Technologies, LLC, Durham, NC (US)

(72) Inventor: Michael S. Fagan, McLean, VA (US)

(21) Appl. No.: 14/514,351

(22) Filed: Oct. 14, 2014

Related U.S. Application Data
(60) Provisional application No. 61/892,498, filed on Oct. 18, 2013.

(51) Int. Cl. H04W 4/02

(52) U.S. Cl. CPC H04W 4/027
USPC 455/456.1

(57) ABSTRACT

Systems and methods for displaying distant images at mobile computing devices are disclosed herein. According to an aspect, a method includes determining a geographic location of a mobile computing device. The method includes determining an orientation of the mobile computing device. Further, the method includes using a user interface of the mobile computing device to receive input of a viewing distance between the geographic location of the mobile computing device and another geographic location. The method also includes communicating to a remote computing device, the geographic location of the mobile computing device, the orientation of the mobile computing device, and the viewing distance. The method also includes receiving from the remote computing device, one or more images associated with the geographic location, the orientation, and the viewing distance. Further, the method includes using a display of the mobile computing device to display the images.

### CROSS REFERENCE TO RELATED APPLICATION

This application claims the benefit of and priority to U.S. Provisional Patent Application No. 61/892,498, filed on Oct. 18, 2013 and titled VIRTUAL BINOCULARS, the content of which is hereby incorporated herein by reference in its entirety.

### TECHNICAL FIELD

The present subject matter relates to displaying images, and more specifically, to systems and methods for displaying distant images at mobile computing devices.

### BACKGROUND

In matters of national security or law enforcement, a military patrol or law-enforcement personnel are often tasked with having to provide surveillance of an area, a target and/or an assembly of people. It may be desired that military patrols or law-enforcement personnel position themselves in a safe or protected area while performing the mission of surveillance or observation. Because of the inherent dangers faced by the military patrols or law-enforcement personnel, to accomplish this mission, the surveying group may visually observe the area or target of interest from a distance or from behind protective structures, such as a hill or building, as an example. The group performing the observation may use tools such as optical binoculars, long-range scopes, periscopes, or the like to visually observe the area or target of interest. Because of variations in terrain or obstructing objects, the observing group may have to partially expose themselves to visually observe the area or target of interest. In some environments, visually observing the area of interest may not even be possible from the vantage point of the observer.

Typical tools for visual observation require the observing group or personnel to compromise safety in exchange for an unobstructed view of an area of interest or an extended line of sight. As an example, a patrol approaching a rise in the terrain may need to climb to the highest point in the terrain in order to observe the reverse slope (e.g., backside of the hill). There can be severe physical or mortal risks associated with having to accomplish direct visual observations using typical tools.

For at least the foregoing reasons, there is a need for improved systems and methods for displaying images of distant locations.

### SUMMARY

Disclosed herein are systems and methods for displaying distant images at a mobile computing device. According to an aspect, a method includes determining a geographic location of a mobile computing device. The method includes determining an orientation of the mobile computing device. Further, the method includes using a user interface of the mobile computing device to receive input of a viewing distance between the geographic location of the mobile computing device and another geographic location. The method also includes communicating to a remote computing device, the geographic location of the mobile computing device, the orientation of the mobile computing device, and the viewing distance. The method also includes receiving from the remote computing device, one or more images associated with the geographic location, the orientation, and the viewing distance. Further, the method includes using a display of the mobile computing device to display the image(s).

According to another aspect, a method includes capturing multiple images of one or more locations. The method also includes receiving from a mobile computing device, a first geographic location of the mobile computing device, an orientation of the mobile computing device, and a distance for viewing from the first geographic location. Further, the method includes determining a second geographic location based on the first geographic location of the mobile computing device, an orientation of the mobile computing device, and a distance for viewing from the first geographic location. The method also includes selecting at least one of the images from among the images that corresponds to the second geographic location. The method also includes communicating the selected image(s) to the mobile computing device.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a diagram of an example system for displaying distant images at a mobile computing device in accordance with embodiments of the present disclosure;

FIG. 2 is a flow chart of an example method for displaying distant images at a mobile computing device in accordance with embodiments of the present disclosure;

FIG. 3 is a diagram of another example system for displaying distant images at a mobile computing device in accordance with embodiments of the present disclosure; and

FIG. 4 is a screen display of an interface for displaying distant images or video and for receiving user input in accordance with embodiments of the present disclosure.

### DETAILED DESCRIPTION

The presently disclosed subject matter is described with specificity to meet statutory requirements. However, the description itself is not intended to limit the scope of this patent. Rather, it is contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present subject matter. A computing device may be, for example, a processing circuit for the detection of a change in voltage level or change in measured capacitance across a circuit. In another example, a computing device may be a server or other computer located within a commercial, residential or outdoor environment and communicatively connected to other computing devices for using computer vision for parafoil flight control. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD). A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable computing device, such as a computer. Other examples of mobile computing devices include, but are not limited to, devices mounted on helmets, in eyeglasses, or as part of a heads-up or multi-function display in ground vehicles or aircraft.

As referred to herein, a “user interface” is generally a system by which users interact with a computing device. A user interface can include an input for allowing users to manipulate a computing device, and can include an output for allowing the system to present information and/or data, indicate the effects of the user's manipulation, etc. An example of an interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a mobile device for interaction. The display object can be displayed on a display screen of a mobile device and can be selected by, and interacted with by, a user using the interface. In an example, the display of the mobile device can be a touch screen, which can display the display icon. The user can depress the area of the display screen at which the display icon is displayed for selecting the display icon. In another example, the user can use any other suitable interface of a mobile device, such as a keypad, to select the display icon or display object. For example, the user can use a track ball or arrow keys for moving a cursor to highlight and select the display object.

Operating environments in which embodiments of the presently disclosed subject matter may be implemented are also well-known. In a representative embodiment, a computing device, such as a mobile device, is connectable (for example, via WAP) to a transmission functionality that varies depending on implementation. Thus, for example, where the operating environment is a wide area wireless network (e.g., a 2.5G network, a 3G network, or the proposed 4G network), the transmission functionality comprises one or more components such as a mobile switching center (MSC) (an enhanced ISDN switch that is responsible for call handling of mobile subscribers), a visitor location register (VLR) (an intelligent database that stores on a temporary basis data required to handle calls set up or received by mobile devices registered with the VLR), a home location register (HLR) (an intelligent database responsible for management of each subscriber's records), one or more base stations (which provide radio coverage with a cell), a base station controller (BSC) (a switch that acts as a local concentrator of traffic and provides local switching to effect handover between base stations), and a packet control unit (PCU) (a device that separates data traffic coming from a mobile device). The HLR also controls certain services associated with incoming calls. Of course, the presently disclosed subject matter may be implemented in other and next-generation mobile networks and devices as well. The mobile device is the physical equipment used by the end user, typically a subscriber to the wireless network. Typically, a mobile device is a 2.5G-compliant device or 3G-compliant device (or the proposed 4G-compliant device) that includes a subscriber identity module (SIM), which is a smart card that carries subscriber-specific information, mobile equipment (e.g., radio and associated signal processing devices), a user interface (or a man-machine interface (MMI)), and one or more interfaces to external devices (e.g., computers, PDAs, and the like). The mobile device may also include a memory or data store.

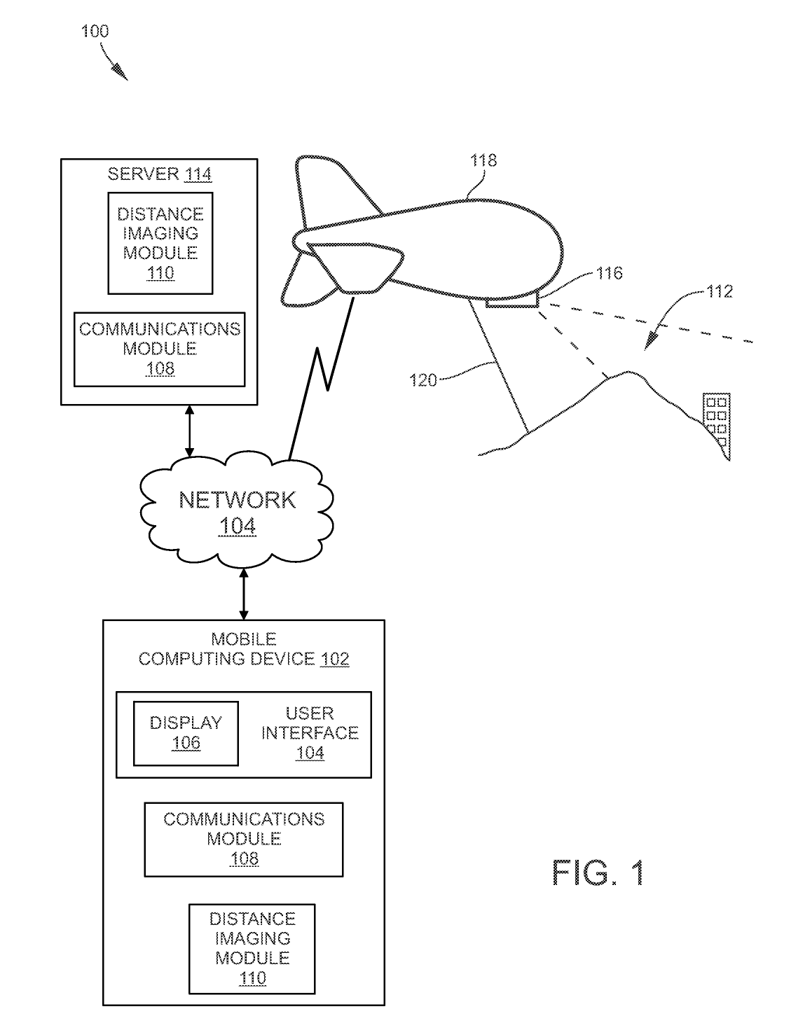

FIG. 1 illustrates a diagram of an example system 100 for displaying distant images at a mobile computing device in accordance with embodiments of the present disclosure. Referring to FIG. 1, the system 100 includes a mobile computing device 102 communicatively connected to a communications network 104. The mobile computing device 102 may be carried by a user in an outside environment, for example. The mobile computing device 102 may include a user interface 104 including a display 106, a communications module 108, and a distance imaging module 110. In the example of FIG. 1, the user of the mobile computing device 102 may interact with the user interface 104 for requesting and receiving one or more images or video of a geographic location, such as geographic location 112. The geographic location 112 is different than a current geographic location of the mobile computing device 102. As will be described in further detail herein, the mobile computing device 102 may be configured to determine a geographic location of the mobile computing device 102, determine an orientation of the mobile computing device 102, and receive user input of a viewing distance between the geographic location of the mobile computing device 102 and another geographic location. Further, the mobile computing device 102 may communicate, to a remote computing device, the geographic location of the mobile computing device 102, the orientation of the mobile computing device 102, and the viewing distance. Subsequently, the mobile computing device 102 may receive from the remote computing device, one or more images or video associated with the data or information communicated to the remote computing device. The mobile computing device 102 may subsequently use the display 106 to display the image(s) or video.

As referred to herein, the term “distant image” can be an image captured at a geographic location that is any distance from a viewer of the captured image. For example, an image-capture device may capture an image of objects and scenery at a geographic location, which is remote from a viewer. The captured image may be communicated to a mobile computing device of the viewer for display to the viewer in accordance with the present disclosure. In one example, objects and scenery in the captured image may not be visible to the viewer from his or her present position due to his or her view being obscured. In another example, objects and scenery in the captured image may be visible to the viewer. In either example, the displayed image may provide the viewer with a better view of the geographic location.

The system 100 may include a server 114 that is communicatively connected to the network 104. The server 114 may be any suitable computing device for connecting to the network 104 via its communications module 110. The network 104 may be any suitable communications network such as, but not limited to, a mobile communications network, the Internet, the like, and combinations thereof. The server 114 may be a web server 114 configured to communicate with the mobile computing device 102 and other computing devices (not shown for ease of illustration). The server 114 may be remote from the mobile computing device 102.

The server 114 may be configured to communicate with one or more image-capture devices 116 via the network 104 and/or one or more other networks. Only one image-capture device 114 is depicted for ease of illustration, although it should be understood that the shown image-capture device 116 may be one of multiple image-capture devices that are each communicatively connected to the server 114. Each image-capture device 116 may be configured to capture images and/or video within view of the respective image-capture device. For example, the image-capture device 116 may include a suitable digital still or video camera configured to capture images or video. The images and video may be continuously or periodically captured by the image-capture devices. Further, the image-capture devices may be controlled by an operator to capture the images.

Images or video captured by an image-capture device may be any suitable image or video that may be displayed or otherwise presented on a computing device. For example, the image or video may be digital image or video of any resolution or type that can be suitably displayed. In an example, the images or video may be infrared images or video.

In the example of FIG. 1, the image-capture device 116 is being carried by a tethered aerostat 118. Aerostats are low-level surveillance systems that use moored balloons as a surveillance platform. The aerostat 118 may include a tether 120 for maintaining the system in a desired position. Alternatively, the aerostat 118 may be free-flying or tethered. Alternatively, for example, equipment for carrying an image-capture system may be a fixed-wing or rotary aircraft, or any other suitable device. In another example, the image-capture system may be suitably placed at any fixed or moving location for capture of images at a desired geographic location. The aerostat 118 may be communicatively connected to the network 104 via a wired or wireless connection.

The image-capture device 116 may be one of multiple image-capture devices that form an image-capture system. The image-capture devices may communicate captured images and/or video to the server 114. The server 114 may store the images and/or video either locally or remotely.

The geographic location 112 may be a persistent viewing area. The viewing area may be defined by geographic location coordinates or by defined targets persisting over time. In this manner, time-based comparisons of images captured by the image-capture device 116 may be made by analysis by a user or by a recipient computing device, such as the server 114. The images and/or video stored by the server 114 may each be associated with a geographic location where the respective image or video was captured. The geographic location may be represented by global positioning system (GPS) coordinates or another suitable indicator of the position of the geographic location. In addition, each image or video may be suitably timestamped for indicating a time when the respective image or video was captured.

The server 114 may include a distance imaging module 110 configured to receive from a mobile computing device, via a communications module 108, a first geographic location of the mobile computing device, an orientation of the mobile computing device, and a distance for viewing from the first geographic location. For example, such information or data may be received from the mobile computing device 102 in accordance with embodiments of the present disclosure. Based on the received information or data, the server 114 may determine a second geographic location, such as geographic location 112. The server 114 may select one or more images or video from among its stored images and video that corresponds to the second geographic location.

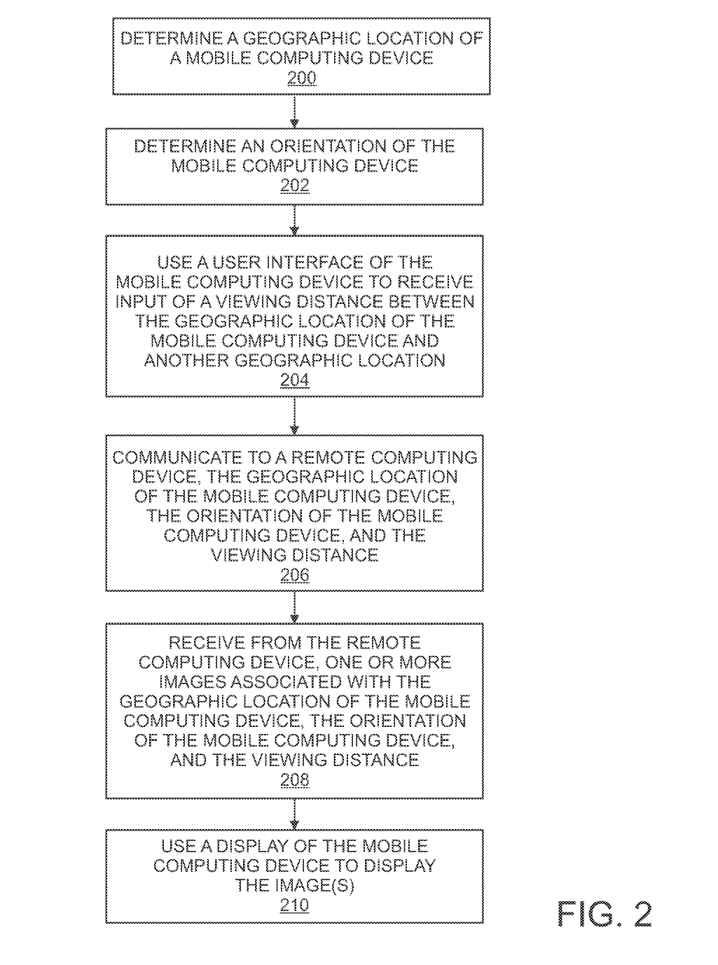

FIG. 2 illustrates a flow chart of an example method for displaying distant images at a mobile computing device in accordance with embodiments of the present disclosure. This example method is described as being implement by the mobile computing device 102 shown in FIG. 1, although it should be understood that any suitable computing device or system may implement the example method.

Referring to FIG. 2, the method includes determining 200 a geographic location of a mobile computing device. For example, the distance imaging module 110 of the mobile computing device 102 shown in FIG. 1 may determine a current or recent geographic location of the mobile computing device 102. The geographic location may be represented by geographic coordinates and stored in memory of the mobile computing device 102. In one example, the mobile computing device 102 may include a global positioning system (GPS) unit that may be suitably used to determine coordinates of the mobile computing device, and to communicate the coordinates to the distance imaging module 110. The geographic location may be a positioned that is the same as the GPS coordinates or a nearby position or area.

The distance imaging module 110 may include hardware, software, firmware, or combinations thereof for implementing the functionality described herein. For example, the distance imaging module 110 may include one or more processors and memory. It is also noted that the functionality of the distance imaging module 110 described herein may be implemented alone or in combination with other modules or devices.

With continuing reference to FIG. 2, the method includes determining 202 an orientation of the mobile computing device. The mobile computing device 102 may include a GPS unit, a gyroscope, an accelerometer, and/or another suitable device or component for determining an orientation of the mobile computing device 102. For example, the device(s) may operate to determine a direction that the mobile computing device 102 is facing. In the examples described herein, the mobile computing device 102 is deemed to be a direction or generally in the direction that a side opposing the display faces. In this case, when a user is looking at the display screen in a typical fashion, the determined direction of orientation of the mobile computing device 102 generally corresponds to the direction that the user is facing.

The method of FIG. 2 includes using 204 a user interface of the mobile computing device to receive input of a viewing distance between the geographic location of the mobile computing device and another geographic location. Continuing the aforementioned example, a user may interact with the user interface to input a viewing distance. The user may include a distance that is estimated or known between the current position and a desired position or area for viewing. As an example of use, the user may be carrying the mobile computing device 102 and face the mobile computing device 102 to an area of desired viewing. The user may subsequently interact with the mobile computing device 102 to enter an estimate of the distance to the area of desired viewing. In one example, the user may input a number and distance unit. In another example, the user may interact with the touchscreen display 106 to enter the distance.

The method of FIG. 2 includes communicating 206 to a remote computing device, the geographic location of the mobile computing device, the orientation of the mobile computing device, and the viewing distance. Continuing the aforementioned example, the distance imaging module 110 may control the communications module 108 to communicate the current geographic location of the mobile computing device 102, the determined orientation of the mobile computing device 102, and the entered viewing distance to the server 114 via the network 104. The server 114 may process the information and data for selecting one or more images and video from among multiple stored images and video. The selected image(s) and/or video may correspond to a geographic location determined based on the first geographic location of the mobile computing device, an orientation of the mobile computing device, and a distance for viewing from the first geographic location. The server 114 may subsequently communicate the selected image(s) and/or video to the mobile computing device 102.

The method of FIG. 2 includes receiving 208 from the remote computing device, at least one image associated with the geographic location of the mobile computing device, the orientation of the mobile computing device, and the viewing distance. Continuing the aforementioned example, the mobile computing device 102 may receive image(s) and/or video from the server 112. Further, the method of FIG. 2 includes using 210 a display of the mobile computing device to display the image(s). For example, the distance imaging module 110 may control the display 106 to display images and/or video received from the server 114.

In accordance with embodiments, the mobile computing device 102 may be configured to present received image(s) or video in a virtual fashion such that the user may view the image from the perspective of the mobile computing device 102. In this manner, a presented image may be viewed from the point of view of the user or the mobile computing device 102 as opposed to the perspective of the aerostat 118. Suitable techniques may be implemented by the device for adjusting one or more captured images or video in this manner such that the displayed images or video appear to be from the perspective of a location of the mobile computing device. The mobile computing device 102 may receive and present image annotations, highlights, and/or landmark identification. This information or data may be stored at the server 114 and provided along with corresponding images or video. The pointing azimuth of the mobile computing device 102 may provide for the correlation of the naked-eye observed scene with the off-board imagery's scene, where the off-board imagery is being recorded by the image-capture device 116 and presented from the perspective of the position of the mobile computing device 102. “Off-board imagery” refers to images being recorded by an image-capture device. The mobile computing device 102, displaying the off-board imagery, may be configured to zoom the displayed image of the off-board imagery to the limit of the off-board imagery scene, and additionally, of varying the viewing area 112 in order to increase the resolution of the screen image. The mobile computing device 102 may continue to display the presented imagery as it is being panned in a horizontal or vertical manner. Additionally, the image(s) presented may be displayed based on a timestamp associated with the imagery.

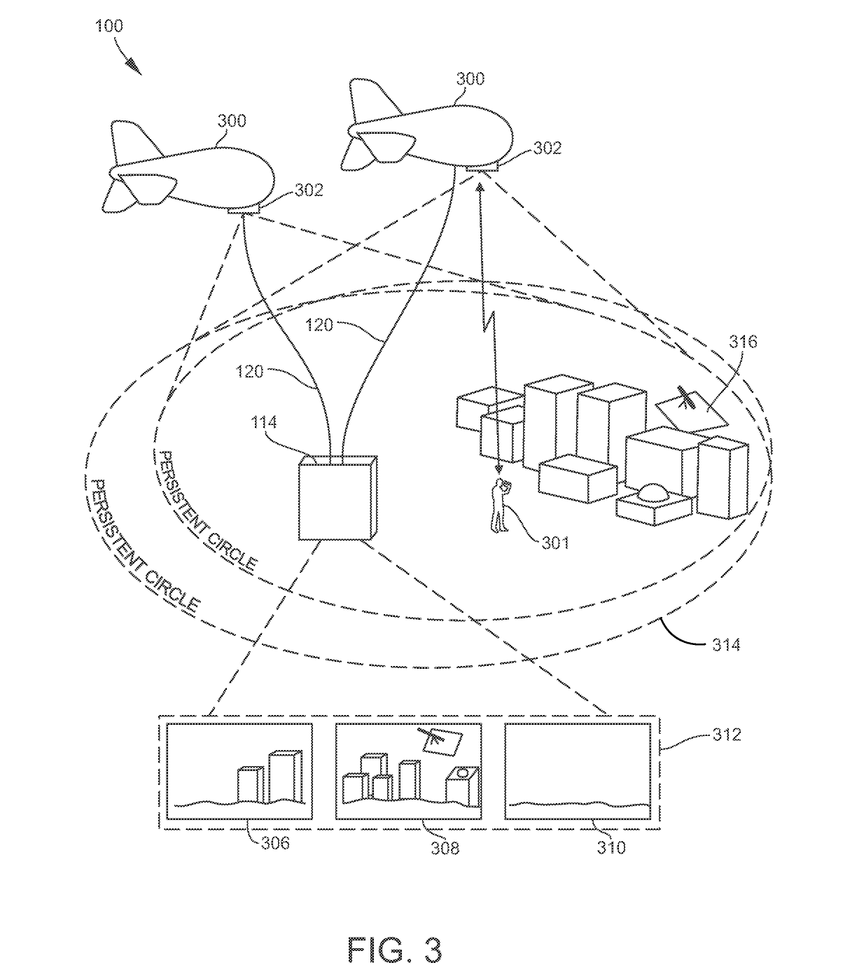

FIG. 3 illustrates a diagram of another example system 100 for displaying distant images at a mobile computing device in accordance with embodiments of the present disclosure. Referring to FIG. 3, the system 100 includes multiple surveillance devices 300 that each include one or more image-capture devices 302. The surveillance devices 300 are aerostats in this example, but it should be understood that the surveillance devices may be any suitable device of capturing images or video. The images and video may be captured of the same geographic location from respective positions of the surveillance devices 300 such that different perspective images and video of the geographic location are captured. Further, the surveillance devices 300 may store their capture images or video in memory. The surveillance devices 300 may suitably communicate captured images or video to a centralized location, such as the server 114 via a suitable communications network.

As mentioned, images and video of a geographic location may be captured of different perspectives of the surveillance devices 300. A distance imaging module of the server 114 may be configured to stitch together captured images 306, 308, and 310 of a geographic location 314 into a single image 312. The images may be stitched together based on a timestamp associated with the captured images. Alternatively, for example, a mobile computing device may receive the captured images 306, 308, and 310 as disclosed and subsequently stitch together images of the geographic location. In this manner, a user 301 of the mobile computing device 136 may quickly and efficiently view points of interest by scrolling or manipulating displayed images presented using a user interface. A displayed image may be a composite of multiple images 202 captured by the surveillance devices 300.

With continued reference to FIG. 3, surveillance devices 302 may be affixed to any suitable airborne platform such as aerostats or aircraft (including unmanned aircraft). In another example, surveillance devices may be affixed to structures such as buildings, towers, or ships. Image-capture devices for use as disclosed herein may be permanently or temporarily affixed to any appropriate airborne device or land-based structure. One or more images or video captured may include an area of interest 316 within the geographic location 314 from an elevation greater than that of the user 301, thus enabling the user 301 to view past intermediate obstructions to vision such as, but not limited to, buildings, terrain, and the like. As an example, a smart phone or the mobile computing device of the user 301 may be operated for opening an application residing on the mobile computing device that can be used to display the area of interest 316 in accordance with embodiments disclosed herein. The mobile computing device's GPS position may be communicated to the server 114, the compass direction of the mobile computing device's orientation may be communicated to the server 114, and the distance to the area of interest 316 may be also be communicated to the server 114. In response to the communication, the mobile computing device of the user may receive one or more images or video of the area of interest 316. The user may control the mobile computing device to zoom into or out from the user's current position to the limit of available imagery. The view may be somewhat analogous to simply viewing the scene with a smart phone's camera, except that the look-down angle on the screen may match that of the surveillance devices 300 used to collect the imagery, and that the aspect angle of the served imagery may not match that of the user 301 who is not located on a line between the surveillance device 300 and the area of interest 316.

In accordance with embodiments, image data communicated to a mobile computing device may include historical or stored image data. The mobile computing device may specify or indicate whether displayed images or data are real-time streaming image data or historical image data. If the displayed image or video data is historical image data, the mobile computing device may display a time of capture or estimated time of capture of the image or video data.

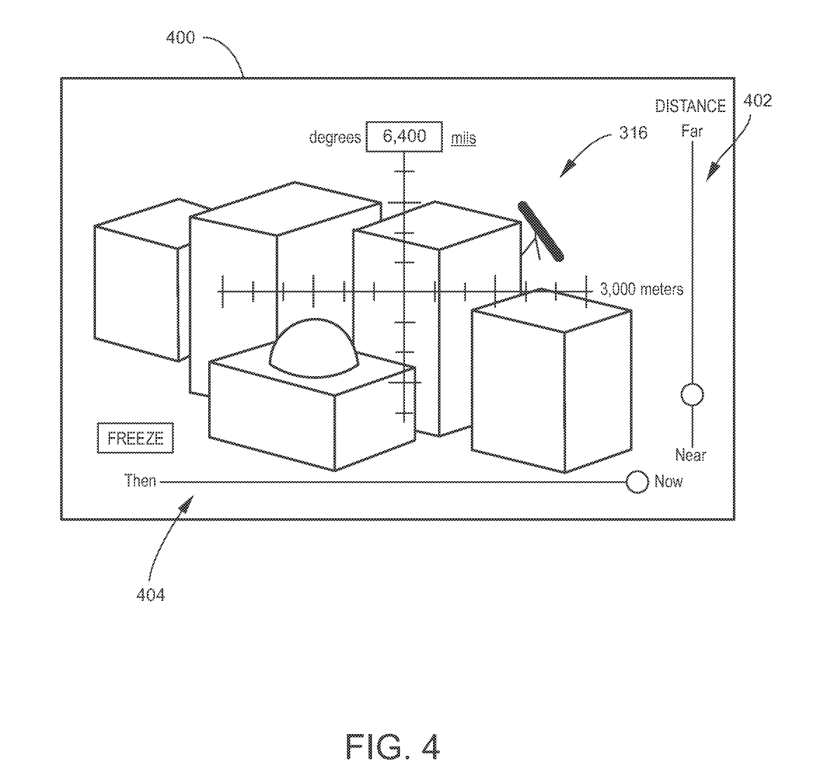

FIG. 4 illustrates a screen display of an interface for displaying distant images or video and for receiving user input in accordance with embodiments of the present disclosure. Referring to FIG. 4, the interface is a screen 400 of a touchscreen display of a mobile computing device. The screen 400 is configured to display images and video and to receive input from the user by user touch of the screen 400. The screen 400 may display an image that can be manipulated by the user or in a predetermined fashion using pre-set modes by a server (or other remote computing device) or the mobile computing device. The display 400 may have on-screen or off-screen controls. On-screen controls may be interacted with via a touch screen or pointing device. Off-screen controls may be interacted with via a keyboard or other physical controls. The screen 400 may be used for viewing images based on the timestamp associated with the image, in a sequenced fashion, in a zoomed or panned fashion based on a distance from a surveillance device, from the user, or from the mobile computing device. As an example, a zoom control 402 displayed on the screen 400 may be a slider configured to be operated by the user to adjust a distance to zoom into or away from the displayed image or video. The screen 400 may have other controls for image manipulation. In another example, the screen 400 may display a timing control 404 that is a slider configured to be operated by a user for adjusting the display of the shown scene in the image based on timing. For example, the user may move the slider 404 to change the time sequence or range of time sequencing displayed on the screen 400. The screen 400 may have other controls for image manipulation, such as, but not limited to altering the marking, annotating, coloration, brightness, contrast, panning, highlights, or any other control of the image as desired by the user. Additional information with respect to target range, size, angular elevation or any other indicator relevant to surveillance, observation or range finding may also be displayed.

The present subject matter may be implemented as a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method comprising:
determining a geographic location of a mobile computing device;
determining an orientation of the mobile computing device;
using a user interface of the mobile computing device to receive input of a viewing distance between the geographic location of the mobile computing device and another geographic location;
communicating to a remote computing device, the geographic location of the mobile computing device, the orientation of the mobile computing device, and the viewing distance;
receiving from the remote computing device, at least one image associated with the geographic location of the mobile computing device, the orientation of the mobile computing device, and the viewing distance; and
using a display of the mobile computing device to display the at least one image.

2. The method of claim 1, further comprising receiving from the remote computing device, identification associated with the at least one image.

3. The method of claim 2, wherein the identification names one of an object and event associated with the at least one image.

4. The method of claim 1, wherein determining the geographic location comprises using a global positioning system (GPS) unit to determine coordinates of the mobile computing device, and
wherein communicating to the remote computing device comprises communicating the coordinates to the remote computing device.

5. The method of claim 1, wherein determining the orientation comprises using one or more of a global positioning system (GPS) unit, a gyroscope, and an accelerometer of the mobile computing device to determine the orientation of the mobile computing device.

6. The method of claim 1, further comprising:
using the user interface to receive input for altering the at least one image for display on the display;
altering the at least one image based on the user input; and
displaying the altered at least one image.

7. The method of claim 1, further comprising:
receiving one of range and azimuth associated with the at least one image; and
using the display to display the one of range and azimuth.

8. The method of claim 1, wherein the at least one image comprises an infrared image.

9. The method of claim 1, wherein the at least one image comprises one of multiple images and video.

10. The method of claim 1, further comprising:
receiving from the remote computing device, a time of capture associated with the at least one image; and
using the display to display the time of capture.

11. A mobile computing device comprising:
a user interface;
a display;
a communications module; and
a distance imaging module comprising at least one processor and memory configured to:
determine a geographic location of the mobile computing device;
determine an orientation of the mobile computing device;
receive, via the user interface, input of a viewing distance between the geographic location of the mobile computing device and another geographic location;
use the communications module to communicate to a remote computing device, the geographic location of the mobile computing device, the orientation of the mobile computing device, and the viewing distance;
receive from the remote computing device, via the communications module, at least one image associated with the geographic location of the mobile computing device, the orientation of the mobile computing device, and the viewing distance; and
use the display to display the at least one image.

12. The mobile computing device of claim 11, receive from the remote computing device, via the communications module, identification associated with the at least one image.

13. The mobile computing device of claim 12, wherein the identification names one of an object and event associated with the at least one image.

14. The mobile computing device of claim 11, further comprising a global positioning system (GPS) unit configured to determine coordinates of the mobile computing device, and
wherein the distance imaging module is configured to communicate the coordinates to the remote computing device.

15. The mobile computing device of claim 11, further comprising one or more of a global positioning system (GPS) unit, a gyroscope, and an accelerometer of the mobile computing device configured to determine the orientation of the mobile computing device.

16. The mobile computing device of claim 11, wherein the distance imaging module is configured to:
receive, via the user interface, input for altering the at least one image for display on the display;
alter the at least one image based on the user input; and
use the display to display the altered at least one image.

17. The mobile computing device of claim 11, wherein the distance imaging module is configured to:
receive, via the communication module, one of range and azimuth associated with the at least one image; and
use the display to display the one of range and azimuth.

18. The mobile computing device of claim 11, wherein the at least one image comprises an infrared image.

19. The mobile computing device of claim 11, wherein the at least one image comprises one of multiple images and video.

20. The mobile computing device of claim 11, wherein the distance imaging module is configured to:
receive from the remote computing device, via the communications module, a time of capture associated with the at least one image; and
use the display to display the time of capture.

21. A system comprising:
an image-capture system configured to capture a plurality of images of one or more locations;
a computing device comprising:
a communications module; and
a distance imaging module comprising at least one processor and memory configured to:
receive from a mobile computing device, via the communications module, a first geographic location of the mobile computing device, an orientation of the mobile computing device, and a distance for viewing from the first geographic location;
determine a second geographic location based on the first geographic location of the mobile computing device, an orientation of the mobile computing device, and a distance for viewing from the first geographic location;
select at least one of the images from among the plurality of images that corresponds to the second geographic location; and
use the communication module to communicate to the mobile computing device, the selected at least one of the images.

22. The system of claim 21, wherein the distance imaging module is configured to:
determine identification associated with the selected at least one of the images; and
communicate, via the communications module, the identification to the mobile computing device.

23. The system of claim 22, wherein the identification names one of an object and event associated with the selected at least one of the images.

24. The system of claim 21, wherein the first geographic location comprises global positioning system (GPS) coordinates of the mobile computing device.

25. The system of claim 21, wherein the selected at least one of the images comprises one of multiple images and video.

26. The system of claim 21, wherein the distance imaging module is configured to communicate to the mobile computing device, via the communications module, a time of capture associated with the selected at least one of the images.

27. The system of claim 21, wherein the selected at least one of the images comprises a plurality of stitched images that corresponds to the second geographic location.

28. The system of claim 21, wherein the image-capture system comprises a plurality of distributed image-capture devices.

29. A method comprising:
capturing a plurality of images of one or more locations;
receiving from a mobile computing device, a first geographic location of the mobile computing device, an orientation of the mobile computing device, and a distance for viewing from the first geographic location;
determining a second geographic location based on the first geographic location of the mobile computing device, an orientation of the mobile computing device, and a distance for viewing from the first geographic location;
selecting at least one of the images from among the plurality of images that corresponds to the second geographic location; and
communicating the selected at least one of the images to the mobile computing device.

30. The method of claim 29, further comprising:
determining identification associated with the selected at least one of the images; and
communicating the identification to the mobile computing device.
